(19) United States
(12) Patent Application Publication
(10) Pub. No.: US 2005/0098034 A1
(43) Pub. Date: May 12, 2005

(54) Hydrogen purification process using pressure swing adsorption for fuel cell applications

(76) Inventors: Craig S. Gittleman, Rochester, NY (US); William Scot Appel, San Diego, CA (US); David Phillip Winter, Encinitas, CA (US); Brian Kenneth Sward, San Diego, CA (US)

Correspondence Address: CARY W. BROOKS;General Motors Corporation, Legal Staff, Mail Code 482-C23-B21, P.O. Box 300, Detroit, MI, 48265-3000, US

(21) Appl. No.: 10/706,320

(22) Filed: Nov. 12, 2003

(51) Int. Cl. B01D 53/02

(52) U.S. Cl. 95/96; 96/121

(57) ABSTRACT

A PSA system that purifies a feed gas, such as a reformate gas in fuel cell system. The PSA system includes a series of vessels housing an adsorbent or combination of adsorbents that adsorb carbon monoxide, carbon dioxide, nitrogen, water and methane in the reformate gas. The adsorbent vessels are connected to each other and a feed manifold, a product manifold and an exhaust manifold through suitable conduits, where the gas flows are controlled by a product rotating valve and feed rotating valve or a series of open/shut valves. A specialized PSA cycle controls the valves so that the vessels cycle through various stages of equalization, blow-down, purge, pressurization and production to purify the feed gas.

### BACKGROUND OF THE INVENTION

1. Field of the Invention

This invention relates generally to a pressure swing adsorption (PSA) system for purifying a gas and, more particularly, a PSA system for purifying hydrogen in a fuel cell system, where the PSA system employs a specialized PSA cycle.

2. Discussion of the Related Art

Hydrogen is a very attractive fuel because it is clean and can be used to efficiently produce electricity in a fuel cell. The automotive industry expends significant resources in the development of hydrogen fuel cells as a source of power for vehicles. Such vehicles would be more efficient and generate fewer emissions than today's vehicles employing internal combustion engines.

A hydrogen fuel cell is an electrochemical device that includes an anode and a cathode with an electrolyte therebetween. The anode receives hydrogen gas and the cathode receives oxygen or air. The hydrogen gas is disassociated in the anode to generate free hydrogen protons and electrons. The hydrogen protons pass through the electrolyte to the cathode. The hydrogen protons react with the oxygen and the electrons in the cathode to generate water. The electrons from the anode cannot pass through the electrolyte, and thus are directed through a load to perform work before being sent to the cathode.

Proton exchange membrane fuel cells (PEMFC) are a popular fuel cell for vehicles. The PEMFC generally includes a solid polymer electrolyte proton conducting membrane, such as a perfluorosulfonic acid membrane. The anode and cathode typically include finely divided catalytic particles, usually platinum (Pt), supported on carbon particles and mixed with an ionomer. The combination of the anode, cathode and membrane define a membrane electrode assembly (MEA). MEAs are relatively expensive to manufacture and require certain conditions for effective operation. These conditions include proper water management and humidification, and control of catalyst poisoning constituents, such as carbon monoxide (CO).

Many fuel cells are typically combined in a fuel cell stack to generate the desired power. The fuel cell stack receives a cathode charge gas that includes oxygen, and is typically a flow of forced air from a compressor. Not all of the oxygen in the air is consumed by the stack and some of the air is output as a cathode exhaust gas that may include water as a stack by-product.

In vehicle fuel cell applications, it is desirable to use a liquid fuel, such as alcohols (methanol or ethanol), hydrocarbons (gasoline), and/or mixtures thereof, such as blends of ethanol/methanol and gasoline, as a source of hydrogen for the fuel cell. Such liquid fuels for the vehicle are easy to store on the vehicle. Further, there is a nationwide infrastructure for supplying liquid fuels. Gaseous hydrocarbons, such as methane, propane, natural gas, LPG, etc., are also suitable fuels for both vehicle and non-vehicle fuel cell applications.

Hydrocarbon-based fuels must be disassociated to release the hydrogen therefrom for fueling the cell. The disassociation reaction is accomplished within a chemical fuel processor or reformer. The fuel processor contains one or more reactors where the fuel reacts with steam, and sometimes air, to generate a reformate gas comprising primarily hydrogen and carbon dioxide. For example, in steam methanol reformation processes, methanol and water are reacted to generate hydrogen and carbon dioxide. However, carbon monoxide and water are also produced. In a gasoline reformation process, steam, air and gasoline are reacted in a fuel processor that contains two sections. One section is primarily a partial oxidation reactor (POX) and the other section is primarily a steam reformer (SR). The fuel processor produces hydrogen, carbon dioxide, carbon monoxide and water.

The known fuel processors also typically include downstream reactors, such as a water/gas shift (WGS) reactor and a preferential oxidation (PROX) reactor. The PROX reactor is necessary to remove carbon monoxide in the reformate gas because carbon monoxide contaminates the catalytic particles in the PEM fuel cell. The PROX reactor selectively oxidizes carbon monoxide in the presence of hydrogen to produce carbon dioxide (CO₂) using oxygen from air as an oxidant. However, the use of a PROX reactor in a fuel processor affects processor performance. For example, control of the air feed is important to selectively oxidize CO to CO₂. Also, the PROX reactor is not 100% selective, and thus results in consumption of hydrogen. Therefore, some hydrogen that would normally be available to provide power is consumed by the PROX reactor. Hence, less power output is provided per a given size stack of fuel cells. Further, the heat generated from the PROX reactor is at low temperature, resulting in excess low-grade heat. Also, typical catalysts used in a PROX reactor contain precious metals, such as platinum or iridium, which are very expensive.

The hydrogen generated in a fuel processor using a PROX reactor for CO clean-up typically contains less than 50% hydrogen, where the balance of the hydrogen-rich reformate gas consists primarily of carbon dioxide, nitrogen and water. Thus, the reformate gas is not suitable for compression and storage because much energy would be wasted in compressing the non-hydrogen components in the reformate gas. Also, valuable storage space would be wasted to contain the non-hydrogen components.

Certain techniques do exist in the art for generating nearly pure hydrogen in non-automotive fuel processing systems. One technique of generating pure hydrogen in a fuel processing system includes the use of hydrogen permeable membranes. These membranes selectively allow the hydrogen to pass through and prevent the other by-products in the reformate gas from permeating through. Typical membranes for these applications contain palladium, which is very expensive. Also, these membranes only operate at relatively high temperatures (250-550° C.), and thus, it takes a long time after the low temperature start-up for a fuel processing system containing hydrogen permeable membranes to be able to generate hydrogen. Additionally, these membranes operate at very high pressures (>5 bar), which leads to high compressor loads and inefficient systems.

It has been suggested in the art that a pressure swing adsorption (PSA) unit can be used to generate nearly pure hydrogen from the reformate gas in a fuel processor system. A fuel cell system employing a PSA unit for this purpose is described in commonly owned U.S. patent application Ser. No. 09/780,184, published Aug. 15, 2002 as publication No. U.S. Pat. No. 2002/0110504 A1, and herein incorporated by reference. In the fuel cell system disclosed in the '184 application, the PSA unit is integrated within the fuel cell stack. The PSA unit uses the anode off-gas from the fuel cell as a purge stream within the PSA unit or uses the cathode off-gas from the fuel cell to combust the low-pressure exhaust gas from the PSA unit. Additionally, both the anode and cathode off-gas can be used. Such a system cannot be used as a stand-alone hydrogen generator, where the hydrogen gas is stored for subsequent use in a fuel cell engine.

U.S. patent application Ser. No. 10/389,375 filed Mar. 14, 2003, titled “Fuel Processor Module for Hydrogen Production for a Fuel Cell Engine Using Pressure Swing Adsorption,” assigned to the assignee of this application, and herein incorporated by reference, also discloses a fuel processor system employing a PSA unit.

In one design, the PSA unit is a rapid-cycle device that includes one input port and two output ports. The reformate gas being purified enters the PSA unit through the input port, the purified hydrogen gas exits the PSA unit through one of the output ports and an exhaust gas including the non-hydrogen gases in the reformate gas exits the PSA unit through the other output port. The PSA unit includes a plurality of compartments or vessels that include an adsorbent that adsorbs the non-hydrogen by-products in the reformate gas. The vessels are rotated between high pressure and low pressure states. When a particular vessel is in a high pressure state, the adsorbent adsorbs the by-products and the smaller hydrogen atoms do not get unadsorbed.

PSA units are typically very large and consist of a minimum of two separate adsorption vessels including numerous valves and manifolds. In a two-vessel system, one vessel would be in the adsorption mode and the other vessel would be in various stations of blow-down, purge and pressurization. Many commercial hydrogen PSA units use four vessels, where one vessel is in the adsorption mode at any given time, and the other three vessels are in the various stages of equalization, blow-down, purge and pressurization. Also, some commercial hydrogen PSA units employ twelve vessels, with four vessels in the adsorption mode at any given time, and the other eight vessels in the various stages of equalization, blow-down, purge and pressurization. It is well known that PSA units with more than two vessels exhibit higher hydrogen recoveries and reduced power by incorporating pressure equalization steps. These PSA units, however, include complex valve arrangements and are non-continuous due to the cycling of these valves.

Adsorption systems have been used in the art for purifying hydrogen generated by the reforming of hydrogen fuel for decades. The first processes were temperature swing adsorbers (TSAs), such as described in U.S. Pat. No. 3,130,942, which used zeolites, such as 13X and 5A, to selectively adsorb impurities from the hydrogen. The impurities were desorbed from the zeolite beds using high temperature regeneration.

Over the years, PSA units were found to be a more cost-effective technique of hydrogen purification than TSAs. However, the PSA equipment and cycles of industrial hydrogen are not ideal for purifying hydrogen for fuel cell applications where autothermal reforming (ATR) or catalytic partial oxidation (CPO) of hydrocarbon fuel are used to generate the hydrogen. Industrial PSA units operate at relatively high pressures, often greater than twenty atmospheres. Processes that require air compression for the ATR or CPO would be inefficient at these elevated pressures, and would preferably operate at pressures of five atmospheres or less. Typical industrial hydrogen PSA units also operate at lower temperatures than those suited for integration with fuel cell systems, where it is not desirable to cool the hydrogen stream to ambient temperature only then to subsequently reheat the hydrogen to the fuel cell stack operating temperature of 60-100° C. Additionally, industrial hydrogen PSA units in steam reforming plants are designed to purify a stream that contains greater than 75% hydrogen, whereas, the product gas from an ATR typically contains no more than 50% hydrogen.

U.S. Pat. No.3,986,849 describes a PSA process for separating hydrogen from gas mixtures that contain carbon dioxide and nitrogen using at least seven adsorbent beds and a PSA cycle with at least three equalization stages. Such systems include at least forty-five valves. U.S. Pat. No. 4,077,779 discloses a multi-bed PSA process for selectively removing carbon monoxide and/or hydrocarbons from hydrogen. The '779 patent describes a four-bed and a six-bed PSA system with at least eight valves required per adsorbent bed. The process was performed at 28.2 atmospheres with a feed gas containing 75% hydrogen.

European Patent Publication No. EP 1 118 370 82 A1 describes a PSA process with ten or more adsorbent beds that utilizes four equalization steps that can be used for hydrogen purification. The cycles described are effective for achieving high hydrogen recovery at three atmospheres and 74% hydrogen in the PSA feed gas. Cycles with large numbers of equalization steps are more efficient at higher pressure, but at lower pressures they add more complexity to the PSA process without providing a significant performance benefit.

International Patent Publication No. WO 02/04096 A1 discloses a process for purifying a hydrogen stream containing carbon monoxide and nitrogen using a Ca exchange X-zeolite at pressures between 20 and 50 bara. U.S. Pat. No.6,302,943 discloses a PSA process for purifying hydrogen from a gas stream containing carbon monoxide and/or nitrogen using a PSA system operating between 100 and 1,000 psig. U.S. Pat. No.6,027,549 discloses s PSA process using an activated carbon with a density between 35 and 38 lb/ft³ for removing carbon dioxide from hydrogen in a PSA process operating above 350 psig. U.S. Pat. No.5,912,422 discloses the use of a lithium-exchange faujasite in a PSA process to remove carbon monoxide from a feed stream containing hydrogen at pressures between 5 and 70 atmospheres. In this process, a first adsorbent is used for removal of carbon dioxide and C₁-C₈ hydrocarbons.

U.S. Pat. No. 4,869,894 describes a vacuum swing adsorption (VSA) process within a steam methane reforming plant that uses five beds and thirty valves. This VSA process is used to purify a stream containing 77% hydrogen at 282 psig. While the use of a vacuum for purging the adsorbents enhances the hydrogen recovery, it has an additional parasitic power load to the PSA system in addition to the high air compression requirements.

U.S. Pat. No.5,753,010 describes a PSA process where a portion of a depressurization and purge of fluent gases from a PSA system is repressurized and then recycled back to the PSA system in order to increase product recovery. This process, which runs at pressure at about 150 psig, requires significant energy for compression, not only for the feed gases to reformer, but also for repressurizing the depressurization and purge of fluent gases from the PSA system.

Some gas purifying processes combine membrane and PSA processes in a hydrogen purification system. U.S. Pat. No. 4,863,492 describes a process where the reformate stream is first fed to a membrane separator to generate a hydrogen rich permeate. The permeate is then fed to a PSA unit to further purify the hydrogen. The feed gas applied to the combined membrane/PSA hydrogen purification system is at least 200 psig. U.S. Pat. No. 4,398,926 discloses a similar process, but where a portion of the membrane retinate is co-fed to the PSA system along with a permeate to improve hydrogen recovery. This process is designed for feed pressures above 600 psig.

Several patents describe processes for hydrogen generation for fuel cells. These include U.S. Pat. No. 6,299,994 and U.S. patent application Publication No. 2002/0110504 A1. However, these patents do not describe the design of a PSA unit with a specific PSA cycle that can accomplish the desired hydrogen purification. U.S. patent Publication No. 2002/0004157 A1 and International Patent Application Publication No. WO 00/16425 disclose rotary PSA hardware designed for purifying oxygen and hydrogen for fuel cell applications. However, these hydrogen PSA units are not designed for the desired relatively low pressures and low feed hydrogen concentrations that are seen in processes which use ATR or CPO for hydrogen generation, and thus, have very low hydrogen recoveries under these conditions.

### SUMMARY OF THE INVENTION

In accordance with the teachings of the present invention, a PSA system is disclosed that purifies a feed gas, such as a reformate gas in fuel cell system. The PSA system includes a series of vessels housing an adsorbent or combination of adsorbents that adsorb carbon monoxide, carbon dioxide, nitrogen, water and methane in the reformate gas. The adsorbent vessels are connected to each other and a feed manifold, a product manifold and an exhaust manifold through suitable conduits, where the gas flows are controlled by a product rotating valve and a feed rotating valve or a series of open/shut valves. A PSA cycle controls the valves so that the vessels cycle through various stages of equalization, blow-down, purge, pressurization and production to purify the gas.

Additional advantages and features of the present invention will become apparent from the following description and appended claims, taken in conjunction with the accompanying drawings.

### BRIEF DESCRIPTION OF THE DRAWINGS

FIG. 1 is a plan view of a PSA system including nine vessels;

FIG. 2 is an illustration of a PSA cycle for the 9-bed PSA system shown in FIG. 1, according to an embodiment of the present invention;

FIG. 3 is an illustration of a PSA cycle for a 9-bed PSA system having three equalization stages, according to another embodiment of the present invention;

FIG. 4 is an illustration of a PSA cycle for a 9-bed PSA system having four equalization stages, according to another embodiment of the present invention;

FIG. 5 is an illustration of a PSA cycle for a 5-bed PSA system having two equalization stages, according to another embodiment of the present invention;

FIG. 6 is an illustration of a PSA cycle for a 12-bed PSA system having three equalization stages, according to another embodiment of the present invention;

FIG. 7 is a plan view of a rotary feed valve for the feed end of a plurality of vessels in a PSA system;

FIG. 8 is a stationary port plate used in combination with the rotary feed valve shown in FIG. 7;

FIG. 9 is a plan view of a rotary product valve for the product end of a plurality of vessels in a PSA system; and

FIG. 10 is a plan view of a stationary port plate used in combination with the rotary product valve shown in FIG. 9.

### DETAILED DESCRIPTION OF THE EMBODIMENTS

The following description of the embodiments of the invention directed to a PSA system for purifying a feed gas is merely exemplary in nature, and is in no way intended to limit the invention or its applications or uses. For example, the discussion below of the PSA system has particular application for purifying a reformate gas in a fuel cell system for a vehicle. However, the PSA system of the invention has a much wider application for other systems and for purifying other gases besides hydrogen.

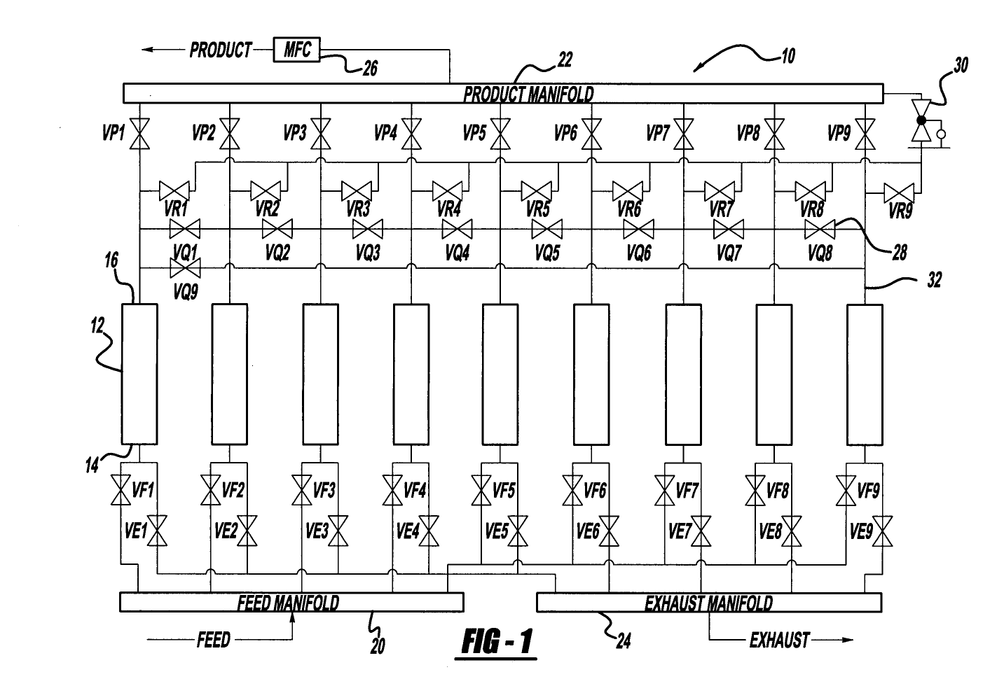

FIG. 1 is a plan view of a PSA system 10 for purifying a feed gas, such as a reformate gas, into a product gas, such as a purified hydrogen gas. The system 10 includes nine columns, beds or vessels 12 each having a feed end 14 that receives the feed gas and a product end 16 that emits the product gas. The vessels 12 include an adsorbent or mixture of adsorbents for adsorbing carbon monoxide, carbon dioxide, nitrogen, water, methane, etc. At least one adsorbent in the vessels 12 is either zeolite 5A or zeolite LiX. A combination or a mixture of zeolite 5A and zeolite LiX can also be used. Additionally, a second adsorbent, such as activated carbon, activated alumina, zeolite 13X or zeolite 4A can be used at the feed end 14 of the vessels 12 for adsorbing some of the water and carbon dioxide in the feed gas. The adsorbents in the vessels 12 will also removed other impurities that may be in the feed gas, such as heavier hydrocarbons like ethane, propane, butane, ethylene, propylene, hydrogen sulfide and/or NH₃.

According to the invention, the PSA system 10 is designed for operation at pressures below seven atmospheres, which is well below the operating pressure of the known hydrogen purifying PSA systems. Also, the PSA system 10 operates at a temperature between 60 and 100° C., which is above the operating temperature of conventional hydrogen purifying PSA systems. Further, the hydrogen product gas contains less than 100 ppm of carbon monoxide, and preferably less than 1 ppm of carbon monoxide. Small amounts (up to 5%) of nitrogen are acceptable for fuel cell applications. This is a much less stringent purity requirement than the output requirement of conventional hydrogen purifying PSA systems, and thus allows for high hydrogen recovery at relatively low operating pressures.

The system 10 includes a feed manifold 20 that is coupled to the feed end 14 of each of the vessels 12 and to a continuous supply of the feed gas from, for example, a reformer or fuel processor (not shown), so that the feed gas from the fuel processor is delivered to the vessels 12. The system 10 also includes a product manifold 22 that collects the product gas from the product ends 16 of the vessels 12 and emits the purified product gas. The purified product gas from the product manifold 22 is sent through a mass flow controller (MFC) 26 to control the amount of product gas that is drawn from the product manifold 22 for the desired fuel cell operation and power output. The system 10 also includes an exhaust manifold 24 coupled to the feed end 14 of each of the vessels 12 that collects and emits the impurities adsorbed by the adsorbents in the vessels 12. The exhaust manifold 24 is typically coupled to a burner or combustor (not shown) for combusting the impurities. The PSA system 10 includes forty-five valves 28 that are controlled by a particular controller (not shown) for the particular system. The controller controls the valves 28 based on a predetermined PSA cycle described below. The various gases described herein are directed through the system 10 by an appropriate system of conduits 32. The system 10 also includes a reducing valve 30 that reduces the pressure and controls the amount of purified gas used to purge the vessels 12.

The valves 28 include nine feed valves VF1-VF9, one for each vessel 12, that control the application of the feed gas from the feed manifold 20 to the feed end 14 of the vessels 12. At any given time, three of the feed valves VF1-VF9 are open during the PSA cycle. The feed valves VF1-VF9 are only open during the production stage of the PSA cycle, as will be described below.

The valves 28 also include nine exhaust valves VE1-VE9, one for each vessel 12, that allow the impurity gas to be drawn from the feed end 14 of the vessels 12 to the exhaust manifold 24. At any given time, either three or four of the exhaust valves VE1-VE9 are open during the PSA cycle. The exhaust valves VE1-VE9 are open during the purge and counter-current blow-down stages of the PSA cycle, as also will be discussed below.

The valves 28 also include nine product valves VP1-VP9, one for each vessel 12, between the product end 16 of the vessels 12 and the product manifold 22. The product valves VP1-VP9 allow the purified product gas to be drawn from the vessels 12 to the product manifold 22 during the production stage, and allow the product gas to flow from the product manifold 22 to the vessels 12 during the counter-current pressurization stage, as will also be described below. At any given time, either three or four of the product valves VP1-VP9 are open during the PSA cycle.

The valves 28 also include nine purge valves VR1-VR9, one for each vessel 12, between the reducing valve 30 and the product end 16 of the vessels 12. The purge valves VR1-VR9 are only open during the counter-current purge step of the PSA cycle, and allow reduced pressure product gas to flow from the product manifold 22 to the product ends 16 of the vessels 12. At any given time, three of the purge valves VR1-VR9 are open during the PSA cycle. In an alternative to the system 10, the reducing valve 30 can be eliminated, and each of the purge valves VR1-VR9 would contain a restricting orifice to reduce the pressure and control the amount of product gas flow from the product manifold 22 to the vessels 12 during the purge stage.

The valves 28 also include nine equalization valves VQ1-VQ9, one for each set of adjacent vessels 12, that allow gas flow between the product end 16 of each vessel 12 and the product end 16 of its two adjacent vessels 12. The equalization valves VQ1-VQ9 are only open during the two product-product equalization stages, described below, and one of the equalization valves VQ1-VQ9 is open at any given time during the PSA cycle.

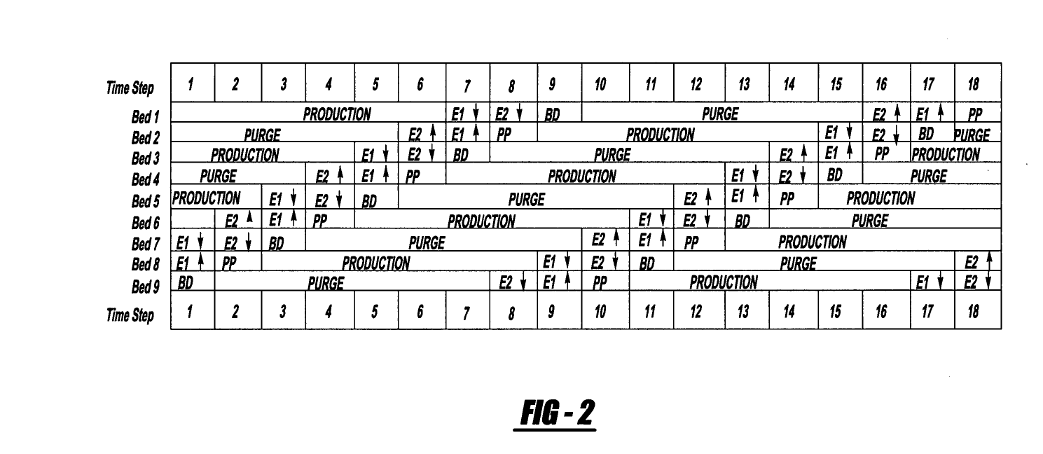

Table I below shows a PSA cycle, according to the invention, for the system 10 that depicts the sequencing of the valves 28. The number on the top column is a particular cycle period, and the identification of the valve 28 below the number shows that that valve 28 is open. FIG. 2 is an illustration of the PSA cycle depicted in Table I. Eighteen cycle periods are shown in FIG. 2 and Table I because each PSA cycle for a particular vessel 12 requires twice as many cycle periods as there are number of the vessels 12.

TABLE I

| Time | | | | | | | | | | | | | | | | | | |
|---|---|---|---|---|---|---|---|---|---|---|---|---|---|---|---|---|---|---|
| Step | 1 | 2 | 3 | 4 | 5 | 6 | 7 | 8 | 9 | 10 | 11 | 12 | 13 | 14 | 15 | 16 | 17 | 18 |
| Open | VF1 | VF1 | VF1 | VF1 | VF1 | VF1 | VQ1 | VQ9 | VE1 | VE1 | VE1 | VE1 | VE1 | VE1 | VE1 | VQ1 | VQ9 | VP1 |
| Valves | VP1 | VP1 | VP1 | VP1 | VP1 | VP1 | VE3 | VP2 | VF2 | VR1 | VR1 | VR1 | VR1 | VR1 | VR1 | VP3 | VE2 | VE2 |
| | VE2 | VE2 | VE2 | VE2 | VE2 | VQ2 | VF4 | VE3 | VP2 | VF2 | VF2 | VF2 | VF2 | VF2 | VQ2 | VE4 | VF3 | VR2 |
| | VR2 | VR2 | VR2 | VR2 | VR2 | VP4 | VP4 | VR3 | VE3 | VP2 | VP2 | VP2 | VP2 | VP2 | VE4 | VR4 | VP3 | VF3 |
| | VF3 | VF3 | VF3 | VF3 | VQ3 | VE5 | VE5 | VF4 | VR3 | VE3 | VE3 | VE3 | VE3 | VQ3 | VF5 | VF5 | VE4 | VP3 |
| | VP3 | VP3 | VP3 | VP3 | VF5 | VR5 | VR5 | VP4 | VF4 | VR3 | VR3 | VR3 | VR3 | VP5 | VP5 | VP5 | VR4 | VE4 |
| | VE4 | VE4 | VE4 | VQ4 | VF6 | VF6 | VF6 | VE5 | VP4 | VF4 | VF4 | VF4 | VQ4 | VE6 | VE6 | VE6 | VF5 | VR4 |
| | VR4 | VR4 | VR4 | VP6 | VP6 | VP6 | VP6 | VR5 | VE5 | VP4 | VP4 | VP4 | VE6 | VR6 | VR6 | VR6 | VP5 | VF5 |
| | VF5 | VF5 | VQ5 | VE7 | VE7 | VE7 | VE7 | VF6 | VR5 | VE5 | VE5 | VQ5 | VF7 | VF7 | VF7 | VF7 | VE6 | VP5 |
| | VP5 | VP5 | VE7 | VR7 | VR7 | VR7 | VR7 | VP6 | VF6 | VR5 | VR5 | VP7 | VP7 | VP7 | VP7 | VP7 | VR6 | VE6 |
| | VE6 | VQ6 | VF8 | VF8 | VF8 | VF8 | VF8 | VE7 | VP6 | VF6 | VQ6 | VE8 | VE8 | VE8 | VE8 | VE8 | VF7 | VR6 |
| | VR6 | VP8 | VP8 | VP8 | VP8 | VP8 | VP8 | VR7 | VE7 | VP6 | VE8 | VR8 | VR8 | VR8 | VR8 | VR8 | VP7 | VF7 |
| | VQ7 | VE9 | VE9 | VE9 | VE9 | VE9 | VE9 | VF8 | VR7 | VQ7 | VF9 | VF9 | VF9 | VF9 | VF9 | VF9 | VE8 | VP7 |
| | VE9 | VR9 | VR9 | VR9 | VR9 | VR9 | VR9 | VP8 | VQ8 | VP9 | VP9 | VP9 | VP9 | VP9 | VP9 | VP9 | VR8 | VQ8 |

The stages of the PSA cycle of Table I and FIG. 2 can be described as follows. As can be seen from FIG. 2, the cycle steps described below are performed in the following sequence. During a production stage of a particular vessel 12, the feed gas is delivered from the feed manifold 20 to the feed end 14 of the vessel 12 through the corresponding feed valve VF, and the product gas is drawn from the product end 16 of the vessel 12 into the product manifold 22 through the corresponding product valve VP. The production stage lasts six cycle periods for each vessel 12.

During a first equalization down (E1 down) stage of a particular vessel 12, the product end 16 of the particular vessel 12 is connected to the product end 16 of an adjacent vessel 12 that is at a lower equalization pressure through the corresponding equalization valve VQ. The E1 down stage lasts for one cycle period. For the discussion below, the particular vessel 12 can be bed 1, the adjacent vessel 12 can be bed 2 and the other adjacent vessel 12 can be bed 9 with reference to FIG. 2. However, it will be understood by those skilled in the art, that all of the vessels 12 in the system 10 go through the same cycle. The adjacent vessel 12 completed a second equalization up (E2 up) stage at the previous cycle time period, described below. The adjacent vessel 12 undergoes a first equalization up (E1 up) stage, described below, while the first vessel 12 is in the E1 down stage. The pressure in the vessel 12 is lowered from the production pressure to the higher equalization pressure during the E1 down stage.

During a second equalization down (E2 down) stage, the product end 16 of the particular vessel 12 is connected to the product end 16 of another adjacent vessel 12 through the corresponding equalization valve VQ that is at a purge pressure having just completed a purge stage during the previous cycle period, described below. The E2 down stage is performed for one cycle period. The other adjacent vessel 12 undergoes a second equalization up (E2 up) stage, while the particular vessel 12 is in the E2 down stage. The pressure in the vessel 12 is lowered from the higher equalization pressure to the lower equalization pressure during the E2 down stage.

During a blow-down (BD) stage, the feed end 14 of the particular vessel 12 is connected to the exhaust manifold 24 through the corresponding exhaust valve VE to reduce the pressure in the particular vessel 12 counter-currently from the lower equalization pressure to an exhaust pressure. The blow-down stage is performed for one cycle period.

During the purge stage, a small amount of product gas from the product manifold 22 is fed to the product end 16 of the particular vessel 12 through the reducing valve 30 and the corresponding purge valve VR to purge the adsorbents of the vessel 12. The reducing valve 30 reduces the pressure of the product gas to a pressure slightly higher than the exhaust pressure before it is used to purge the adsorbents of the vessel 12. The purge gas containing the now desorbed impurities is drawn from the feed end 14 of the vessel 12 into the exhaust manifold 24 through the corresponding exhaust valve VE. In this embodiment, the purge stage lasts for six consecutive cycle periods. However, as will be discussed below, the purge stage can be reduced in time to add more equalization stages.

During the E2 up stage, the product end 16 of the particular vessel 12 is connected to the product end 16 of the adjacent vessel 12 through the corresponding equalization valve VQ, which is now at the higher equalization pressure having just completed the E1 down stage at the previous cycle period. The E2 up stage is performed for one cycle period. The adjacent vessel 12 undergoes the E2 down stage while the first vessel 12 is in the E2 up stage. The pressure in the vessel 12 is raised from the exhaust pressure to the lower equalization pressure during the E2 up stage.

During the E1 up stage, the product end 16 of the particular vessel 12 is connected to the product end 16 of the other adjacent vessel 12 through the corresponding equalization valve VQ, which is now at the production pressure having just completed the production stage discussed above at the previous cycle period. The other adjacent vessel 12 undergoes the E1 down stage, while the particular vessel 12 is in the E1 up stage. The pressure in the vessel 12 is raised from the lower equalization pressure to the higher equalization pressure. The E1 up stage is performed for one cycle period.

During the product pressurization (PP) stage, product gas flows from the product manifold 22, through the corresponding product valve VR, to the product end 16 of a particular vessel 12 to pressurize the vessel 12 from the higher equalization pressure to the production pressure. The product pressurization stage is performed for one cycle period. After the product pressurization stage, the particular vessel 12 moves to the production stage, discussed above, and the cycle begins again.

There are several variations of the stages of the PSA cycle described above. For example, the relative times of the blow-down and purge stages can be changed, as long as the total time of the blow-down plus purge is seven cycle periods. In another alternate embodiment, instead of using the purified hydrogen gas to pressurize the vessels 12 from the higher equalization pressure to the production pressure in the product pressurization stage, the feed gas can be used to pressurize the vessel 12. The vessel 12 would then be pressurized from the feed end 14 of the vessel 12 in a feed pressurization stage. In this embodiment, feed gas from the feed manifold 20 would flow through the corresponding feed valve VF to the feed end 14 of the vessel 12 during the feed pressurization stage.

Another variation of the PSA cycle that has shown performance enhancement includes providing a simultaneous equalization from both the feed end 14 and the product end 16 of the vessels 12. In that situation, the product end 16 of the particular vessel 12 is connected to the product end 16 of the adjacent vessel 12 through the corresponding equalization valve VQ while the feed end 14 of the vessel 12 is simultaneously connected to the feed end 14 of the adjacent vessel 12 to allow the vessel 12 to equalize from both directions. In order to enable such a dual end equalization stage within the PSA cycle, an additional nine equalization valves VQ would need to be added to the feed end 14 of the vessels 12.

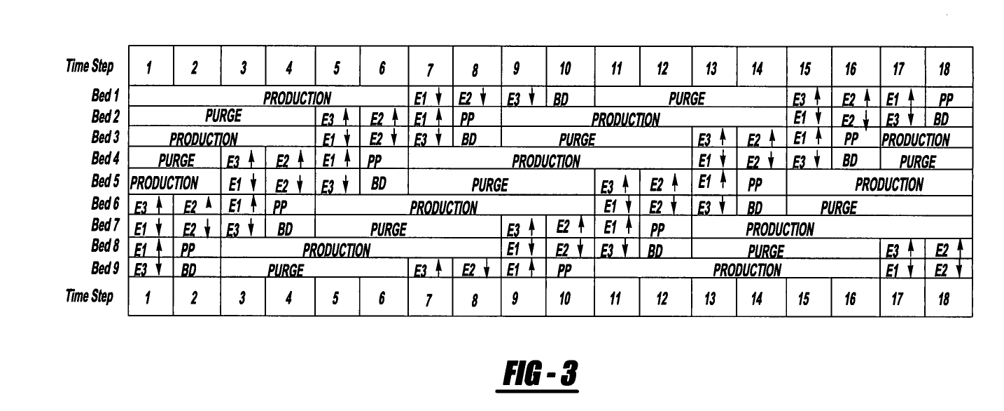

A PSA cycle for the system 10 can be employed that has three or four equalization stages. The PSA cycle for a 9-bed PSA system with three equalization stages is illustrated in FIG. 3. In order to accommodate for the extra equalization stage, the duration of the purge stage is reduced by two cycle periods from the PSA cycle shown in FIG. 2. This is because the added E3 down stage and the E3 up stage each require a single cycle period. The advantage of a PSA cycle with more equalization stages would be a higher hydrogen product recovery. However, more valves 28 would be required as more equalization steps are added. For example, a 9-bed PSA system operating with a three equalization stage PSA cycle would have fifty-four valves 28, and would also need an additional manifold for equalization gas flow.

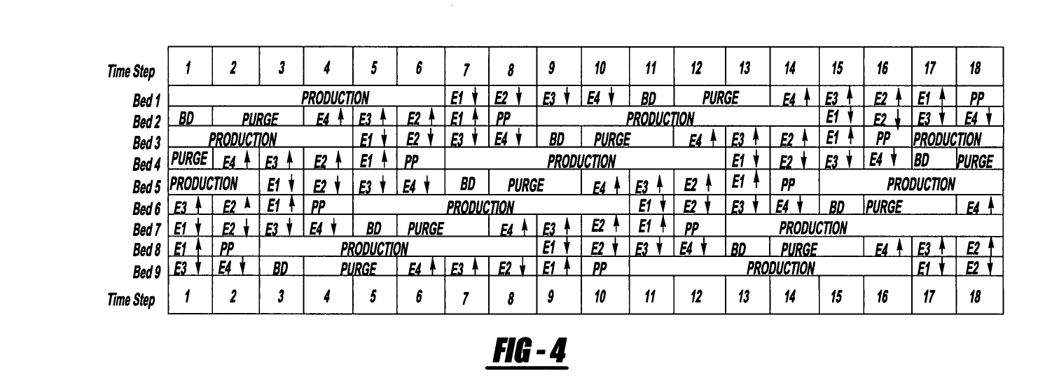

Similarly, a PSA cycle for a 9-bed PSA system with four equalization stages would have an even shorter purge stage, as illustrated in FIG. 4. Effective purging of the adsorbent could still be accomplished, even in a shorter time, by increasing the amount of purge gas allowed through the reduction valve 30. A 9-bed PSA system operating with a four-equalization stage PSA cycle would have sixty-three valves 28, and two additional manifolds for equalization gas flow.

The PSA system 10 of the invention is not specifically limited to 9-beds. It is recommended that the system 10 have at least five adsorbent vessels 12 to enable at least two equalization stages. A PSA cycle for a 5-bed PSA system with two equalization stages is illustrated in FIG. 5. A fixed-bed PSA system operating with this PSA cycle would need twenty-five valves 28, and thus, would be a simpler system than the 9-bed PSA system 10 described above. However, the productivity of the 5-bed PSA cycle is lower than that of the 9-bed PSA cycle as the percentage of the cycle that each bed is in the production stage is lower in the 5-bed system (2 of 10 time steps or 20%) than in the 9-bed system (6 of 18 time steps or 33.3%). Thus, the choice of the optimal number of beds used in the PSA cycle is a trade off between performance, i.e. recovery and productivity, versus cost and complexity.

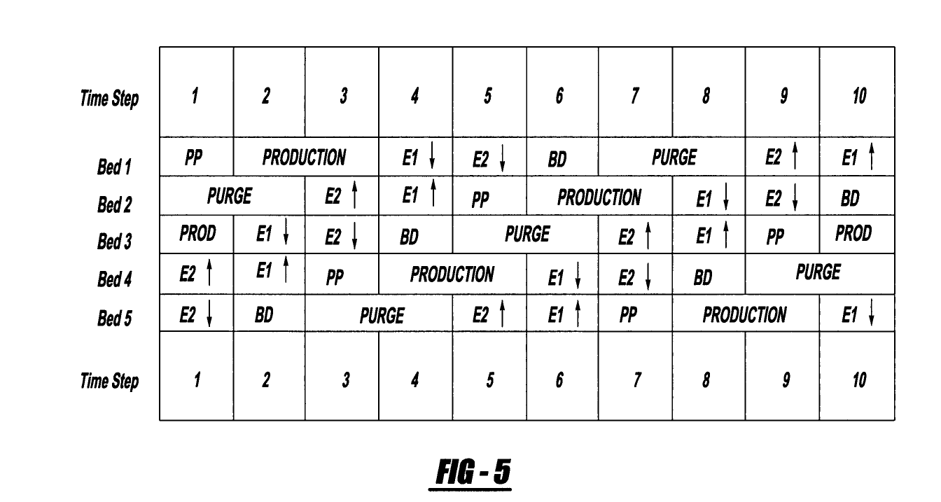

The cycle for a PSA system with more than nine vessels 12 can also be used. For example, a 12-bed PSA system with three-equalization stages, 33.3% of the cycle as production, and equal production and purge stage duration is illustrated in FIG. 6.

Conventional PSA systems, such as those described above, require many of the valves 28 to control the PSA cycle. Another way to control a multi-bed PSA cycle is with rotary valves. PSA systems employing rotary valves are described in U.S. Pat. Nos. 4,925,464; 5,112,367 and 5,366,541. These patents describe devices that use a single rotary valve, which rotates relative to a stationary port plate, to direct gases to the numerous vessels in the PSA system as defined by the particular PSA cycle.

Systems with only one rotary valve directing flow to the feed end 14 of the vessels 12 are limited to using PSA cycles with feed-feed equalization. However, any cycle that can be defined using a collection of valves can be replicated by using two rotary valves, one at the feed end 14 of the vessels 12 and one at the product end 16 of the vessels 12. Such PSA systems with two rotary valves are described in U.S. Pat. Nos. 5,820,656 and 5,891,217.

Alternately, a single rotary valve can communicate with both the feed end 14 and the product end 16 of a series of the vessels 12 to generate a desired PSA cycle. Such PSA systems with a signal rotary valve coupled to both ends of the vessels in a PSA system are described in U.S. Pat. Nos. 5,807,423; 5,814,130; and 5,814,131. The rotary valve systems described in these patents have the advantage of being more simple, compact, quiet and continuous than PSA systems with a large number of pneumatically or electrically controlled valves. Rotary valve PSA systems also have the advantage of being able to operate with very rapid cycles given the selection of an appropriate adsorbent. By operating with very short cycles, as short as one second, very compact PSA systems can be designed.

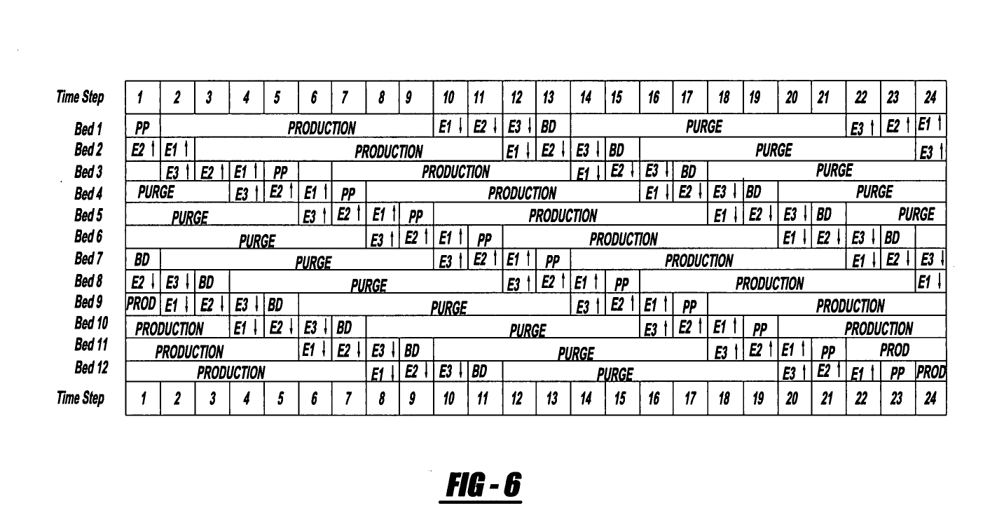

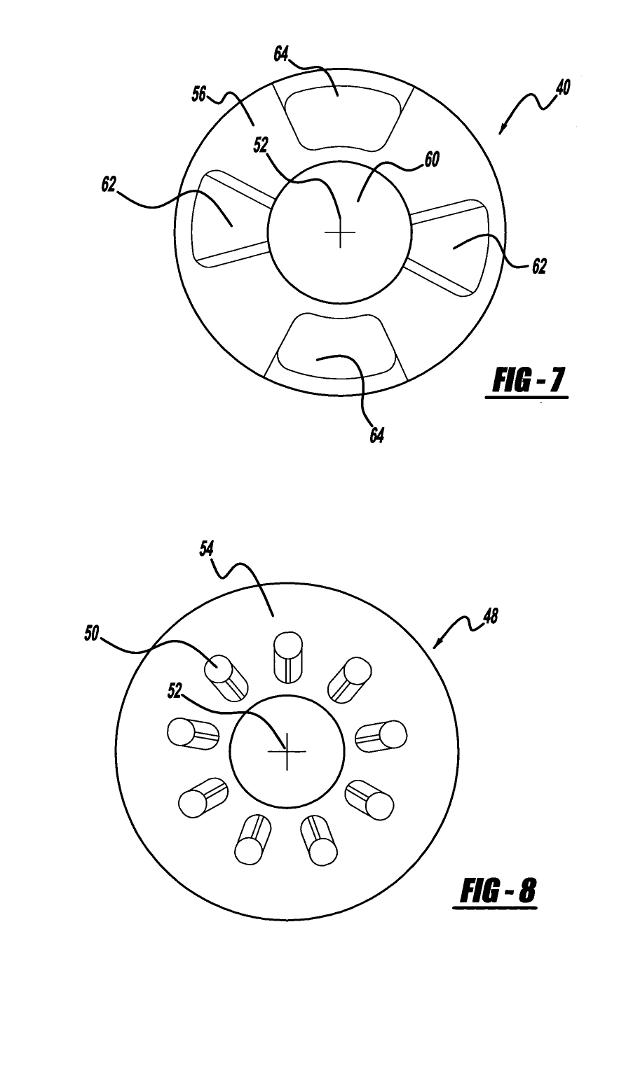

An example of how a PSA system with two rotary valves can generate a PSA cycle of the invention is described below. FIG. 7 is a plan view of a rotary feed valve 40 that can replace all of the feed valves VF1-VF9 and the exhaust valves VE1-VE9 in the system 10. FIG. 8 is a plan view of a stationary feed port plate 48 used in combination with the feed valve 40, as discussed below. A face 54 of the feed port plate 48 is lapped flat to within 20 millionths of an inch to a face 56 of the valve 40. The rotary feed valve 40 is aligned to a center axis 52 so that its face 56 is in direct contact and completely flush with the face 54 of the feed port plate 48. The feed port plate 48 includes nine feed apertures 50, one for each vessel, evenly spaced (40° apart) at the same radial distance from the center axis 52. The nine apertures 50 are each connected to a respective feed end 14 of the vessels 12 through a suitable conduit (not shown).

The feed manifold 20 provides the feed gas to the feed valve 40 through a center port 60 in the valve 40 through a suitable conduit, and distributes it to two feed gas ports 62 that are spaced 180° apart. The width of each feed port 62 is set so that when the valve 40 is placed in contact with the feed port plate 48, each feed port 62 will deliver the feed gas to either one or two of the feed apertures 50. At every possible position, the two feed ports 62 deliver the feed gas to three of the feed apertures 50. The vessels 12 that are receiving the feed gas through the feed ports 62 and the apertures 50 are in the production stage of the PSA cycle. At any point in time, three of the nine vessels 12 are in the production stage.

The valve 40 includes two exhaust gas ports 64 that communicate with the exhaust manifold 24, which in this example is in direct contact with the outer circumference of the feed valve 40. The exhaust gas ports 64 are spaced 180° apart on the face 56 of the valve 40. The width of each exhaust gas port 64 is set so that when the valve 40 is placed in contact with the feed port plate 48, each exhaust port 64 receives exhaust gas from either one or two of the feed apertures 50 through a suitable conduit (not shown) coupled to the feed end 14 of the vessels 12. At every possible position, the exhaust gas ports 64 receive the exhaust gas from either three or four of the feed apertures 50. The exhaust gas is received by the exhaust manifold 24 through the exhaust ports 64 and the feed apertures 50 during the blow-down and purge stages of the PSA cycle. At any point in time, three of the nine vessels 12 are in the purge stage and zero or one of the vessels 12 is in the blowdown stage.

When an aperture 50 is fully covered by the face 56 of the feed valve 40, no gas flows into or out of the feed end 14 of the corresponding vessel 12. This situation exists during the equalization and product pressurization stages of the PSA cycle. At any given time, either two or three of the apertures 50 are fully covered by the face 56 of the feed valve 40. The feed valve 40 rotates counter clockwise along the axis 52 relative to the feed port plate 48 to generate the PSA cycle described above and shown in FIG. 2. Each rotation of the feed valve 40 is equivalent to two of the PSA cycles shown in FIG. 2.

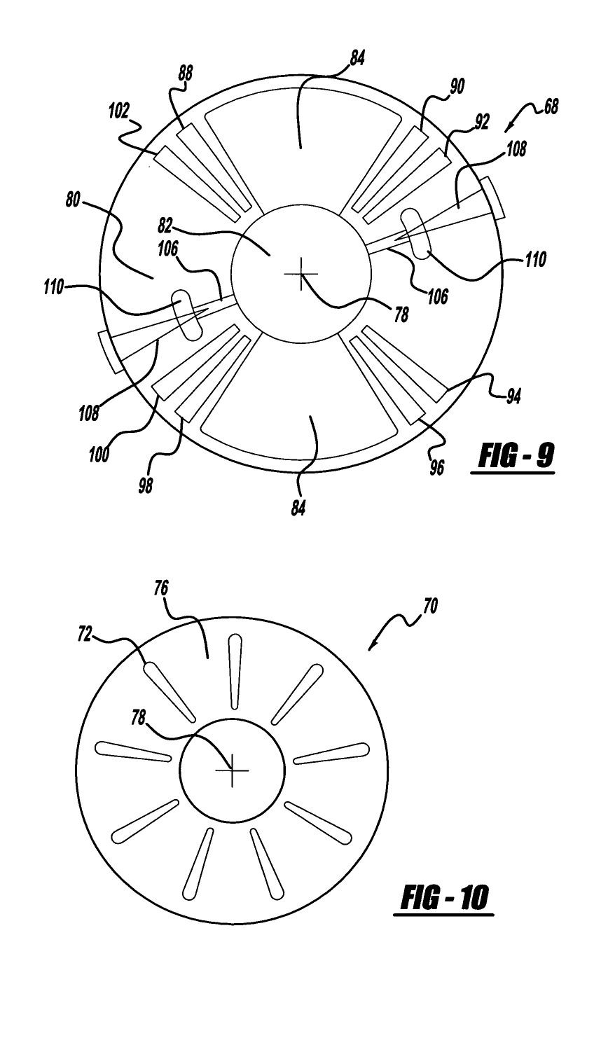

FIG. 9 is a plan view of a rotary product valve 68 that can replace all of the product valves VP1-VP9, the purge valves VR1-VR9 and the equalization valves VQ1-VQ9 in the system 10. FIG. 10 is a plan view of a stationary product port plate 70 used in combination with the product valve 68. The port plate 70 includes nine product apertures 72, one for each vessel 12, that are evenly spaced (40° apart) at the same radial distance from a center axis 78. The apertures 72 are connected to the product end 16 of each of the nine vessels 12 by a suitable conduit (not shown). A face 76 of the product port plate 70 is lapped flat to within 20 millionths of an inch of a face 80 of the valve 68. The product valve 68 is aligned with the axis 78 so that its face 80 is in direct contact and completely flush with the face 76 of the feed plate port 70.

The product manifold 22 is connected to the product valve 68 by a center port 82 in the valve 68 through a suitable conduit. The center port 82 is connected to two product gas ports 84 that are spaced 180° apart. The width of each product port 84 is set so that when it is placed in contact with the product port plate 70, each product port 84 will exchange product gas with either one or two of the product apertures 72. At every possible position, two of the product ports 84 will exchange product gas to either three or four product apertures 72. The vessels 12 will exchange product gas through the product ports 84 and the product apertures 72 during the production stage and the product pressurization stage of the PSA cycle as described above. At any point in time, three of the nine vessels 12 are in the production stage and either zero or one of the vessels 12 is in the product pressurization stage.

The valve 68 includes eight equalization ports 88-102. The equalization ports 88 and 102, the equalization ports 90 and 92, the equalization ports 94 and 96 and the equalization ports 98 and 100 are spaced 100 apart. The equalization ports 88 and 90, the equalization ports 92 and 94, the equalization ports 96 and 98 and the equalization ports 100 and 102 are spaced 80° apart. The equalization ports 88 and 90, the equalization ports 92 and 94, the equalization ports 96 and 98, and the equalization ports 100 and 102 are connected to each other through discrete conduits within the valve 68. The equalization ports 88-102 are wide enough to just cover one product aperture 72. At any given time, two equalization ports 88-102, which are connected to each other, i.e., ports 88 and 90, are exchanging gas with two product apertures 72. The other six equalization ports 88-102 are fully covered by the face 76 of the product port plate 70.

During the E1 stages, gas flows from either the equalization port 88 or 96, which are receiving gas from a vessel 12 that is in the E1 down stage, to the equalization ports 90 or 98, respectively, which are delivering gas to a second vessel 12 that is in the E1 up stage. During the E2 stages, gas flows from either the equalization ports 94 or 102, which are receiving gas from a vessel 12 that is in the E2 down stage, to the equalization ports 92 or 100, respectively, which are delivering gas to a second vessel 12 that is in the E2 up stage.

The product valve 68 includes two purge gas ports 110. The purge gas ports 110 are spaced 180° apart at the same radial distance from the center axis 78. The product gas flows from the center port 82 to purge gas ports 110 via purge conduits 106. Adjustable screws 108, which behave like needle valves within the product valve 68, control the flow of product gas through the purge conduits 106. The adjustable screws 108 are thus used to control the amount of product gas that flows from the product manifold 22 into the product end 16 of the vessels 12 via the purge conduits 106 and the purge gas ports 110 during the purge stage. The adjustable screws 108 are also used to reduce the pressure of the product gas to that of the purge gas. At every possible position, the purge gas ports 110 will deliver reduced pressure product gas to three of the product apertures 72. The vessels 12 that are receiving the reduced pressure product gas through the purge gas ports 110 and the apertures 72 are in the purge stage of the PSA cycle. At any point in time, three of the nine vessels 12 are in the purge stage during the PSA cycle.

When an aperture 72 is fully covered by the face 80 of the product valve 68, no gas flows into or out of the product end 14 of the vessels 12. The situation exists for very short times between the various PSA stages and during the counter-current blow-down stage of the PSA cycle.

The product valve 68 rotates clockwise on the axis 78 relative to the product port plate 70 to generate the PSA cycle described above and shown in FIG. 2. Each rotation of the product valve 68 is equivalent to two PSA cycles as described in FIG. 2. The feed valve 40 and the product valve 68 rotate about the same center axis 78 at the same speed and, therefore, are driven by a single common motor.

Rotary valves and stationary port plates could readily be designed for any PSA cycle, including those shown in FIGS. 3-6. For the 9-bed cycles illustrated in FIGS. 3 and 4, different feed and product valves only need to be designed, as opposed to the addition of one on/off valve per bed for each additional equalization stage in the PSA system 10 illustrated in FIG. 1. Different feed and product port plates would be necessary depending on the number of the vessels in the PSA system 10, with the port plates having one aperture for each vessel 12.

The same PSA cycles could be generated using a single rotating valve system with a single port plate that contains two sets of apertures. There would be one set of apertures communicating with the feed ends of the vessels 12, and a second set of apertures communicating with the product ends of the vessels 12. The two sets of apertures would be located at different radial distances from the axis of rotation. Such a valve and port plate could be readily designed and is not necessary to be described in detail here.

The PSA system of the invention is designed to purify hydrogen generated by autothermal reforming of a hydrocarbon fuel, such as gasoline, diesel fuel, natural gas, LPG or methanol. Because of the high parasitic loads of air compression, autothermal reactors are not typically run at pressures above 7 bar, and more typically are run at about 3 bar. Typically, the reformate gas generated in the autothermal reactor is fed to a WGS reactor or series of WGS reactors to improve the overall conversion to hydrogen, and to reduce the carbon monoxide content in the reformate gas. The reformate gas has a typical concentration of 35-59% of hydrogen, 5-20% of carbon dioxide, 1-5% of carbon monoxide, 25-40% of nitrogen and 0-1% of methane. The reformate gas is also typically saturated with water (100% RH). The PSA system should operate at a temperature close to that of the fuel cell stack, typically between 60-100° C., so as to minimize the amount of temperature control equipment in the hydrogen generation process. The PSA system should also be able to operate at ambient temperatures so as to be able to deliver the purified hydrogen while the vessels are warming up to their operating temperatures.

The PSA system of the invention is designed to separate hydrogen from a reformate mixture within this range of concentrations. The PSA system of the invention is designed for operation at pressures between 3 and 7 atmospheres, and temperatures between 20 and 100° C. The PSA system of the invention will generate a hydrogen product gas with at least 95% hydrogen and preferably 99% hydrogen. The hydrogen product gas will contain no more than 100 ppm carbon monoxide, and preferably less than 10 ppm carbon monoxide, and most preferably, less than 1 ppm carbon monoxide.

In one example, a 9-bed PSA system was equipped with the rotary valves and port plates shown in FIGS. 7-10 and used the PSA cycle illustrated in FIG. 2. The adjustable screws 108 in the product valve 68 were set so that 7 SLPM of nitrogen would flow through each purge gas port 110 when 30 psig of nitrogen was applied to the product manifold 22 and there was no back pressure down stream of the purge gas ports 110. Each of the vessels 12 was filled with 378 g of UOP 5 A-MG adsorbent. 280 SLPM of reformate (47.4% hydrogen, 1.0% carbon monoxide, 15.2% carbon dioxide, 5.9% water, and 30.5% nitrogen), at 35.7 psig and 70° C. was fed into the feed manifold 20 of the PSA system 10. The force at which the valves 40 and 68 and the port plates 48 and 70 are compressed together was optimized for these operating conditions. The valves 40 and 68 were rotated at 6.1 rpm, generating a PSA cycle time of 4.9 s. The product gas collected from the PSA system 10 at steady state is summarized in table 11 below. 70% of the hydrogen in the feed gas is recovered, which is unexpectedly high for a PSA system operating at 35 psig. Also, the product carbon monoxide is within acceptable levels for PEM fuel cell operation.

TABLE II

| | | |
|---|---|---|
| Product Flow | 96 | SLPM |
| Pressure | 34.7 | psig |
| Temperature | 60 | ° C. |
| H₂ content | 96.5 | % |
| CO content | 40 | ppm |
| N₂ content | 3.5 | % |
| H₂ Recovery | 70 | % |

In another example, a 9-bed PSA system equipped with the rotary valves 40 and 68 and the port plates 48 and 70, shown in FIGS. 7-10, and used the PSA cycle depicted in FIG. 2. The adjustable screws 108 in the product valve 68 were set in the same position as in the example discussed above. The force at which the valves 40 and 68 and the port plates 48 and 70 are compressed together was also the same as in that example. Each of the vessels 12 was filled with 378 g of UOP 5 A-mg adsorbent. 280 SLPM of reformate gas, 47.4% hydrogen, 1.0% carbon monoxide, 15.2% carbon dioxide, 5.9% water and 30.5% nitrogen, at 45.2 psig and 70° C. was fed into the feed manifold 20 of the PSA system 10. The valves 40 and 68 were rotated at 3.8 rpm, generating a PSA cycle time of 7.9 seconds. The product gas collected from the PSA system 10 at steady state is summarized in table III below. Over 73% of the hydrogen in the feed gas is recovered. There is also a four fold reduction in the product carbon monoxide, resulting from the relatively small increase in pressure from the example discussed above. It is reasonable to expect that the recovery could be improved further by optimizing the purge gas flow rate by adjusting the adjustable screws 108 and by optimizing the force at which the valves 40 and 68 and the port plates 48 and 70 are compressed together.

TABLE III

| | | |
|---|---|---|
| Product Flow | 100 | SLPM |
| Pressure | 44.2 | psig |
| Temperature | 60 | ° C. |
| H₂ content | 96.4 | % |
| CO content | 10 | ppm |
| N₂ content | 3.6 | % |
| H₂ Recovery | 73.3 | % |

The foregoing discussion discloses and describes merely exemplary embodiments of the present invention. One skilled in the art will readily recognize from such discussion and from the accompanying drawings and claims that various changes, modifications and variations can be made therein without departing from the spirit and scope of the invention as defined in the following claims.

1. A method for cycling a pressure swing adsorption (PSA) system, said PSA system receiving a feed gas and emitting a purified product gas and an exhaust gas, said method comprising:
providing a plurality of vessels, each vessel including an adsorbent for adsorbing impurities in the feed gas, each vessel further including a feed end responsive to the feed gas and emitting the exhaust gas, and a product end that emits the product gas;
operating each vessel of the plurality of vessels in a production stage for a plurality of cycle periods, wherein operating the vessel in the production stage includes delivering the feed gas to the feed end of the vessel and drawing the product gas from the product end of the vessel;
operating each vessel of the plurality of vessels in a first equalization down stage following the production stage for at least one cycle period, wherein operating the vessel in the first equalization down stage includes coupling the product end of the vessel to the product end of an adjacent vessel that is at a lower pressure to lower the pressure in the vessel;
operating each vessel of the plurality of vessels in a second equalization down stage following the first equalization down stage for at least one cycle period, wherein operating the vessel in the second equalization down stage includes coupling the product end of the vessel to the product end of another adjacent vessel that is at a purge pressure to further lower the pressure in the vessel;
operating each vessel of the plurality of vessels in a blow-down stage following the second equalization down stage for at least one cycle period, wherein operating the vessel in the blow-down stage further reduces the pressure in the vessel to an exhaust pressure;
operating each vessel of the plurality of vessels in a purge stage following the blow-down stage over a plurality of cycle periods, wherein operating the vessel in the purge stage includes feeding reduced-pressure product gas into the product end of the vessel and emitting the exhaust gas through the feed end of the vessel;
operating each vessel of the plurality of vessels in a second equalization up stage following the purge stage for at least one cycle period, wherein operating the vessel in the second equalization up stage includes coupling the product end of the vessel to the product end of an adjacent vessel that is at a higher pressure to increase the pressure in the vessel;
operating each vessel of the plurality of vessels in a first equalization up stage following the second equalization up stage for at least one cycle period, wherein operating the vessel in the first equalization up stage includes coupling the product end of the vessel to the product end of another adjacent vessel that is at a higher pressure to further increase the pressure in the vessel;
operating each vessel of the plurality of vessels in a product pressurization stage following the first equalization up stage for at least one cycle period, wherein operating the vessel in the product pressurization stage includes pressurizing the vessel with product gas to a product pressure; and
operating each vessel of the plurality of vessels in the production stage following the product pressurization stage.

2. The method according to claim 1 wherein operating each vessel in the first equalization down stage includes operating the adjacent vessel in the second equalization down stage during the previous cycle period and operating the adjacent vessel in the first equalization up stage while the vessel is operating in the first equalization down stage.

3. The method according to claim 1 wherein operating each vessel in the second down equalization stage includes operating the other adjacent vessel in the purge stage during the previous cycle period and operating the other adjacent vessel in the second equalization up stage while the vessel is operating in the second equalization down stage.

4. The method according to claim 1 wherein operating each vessel in the second equalization up stage includes operating the adjacent vessel in the first equalization down stage during a previous cycle period and operating the adjacent vessel in the second equalization down stage while the vessel is operating in the second equalization up stage.

5. The method according to claim 1 wherein operating each vessel in the first equalization up stage includes operating the other adjacent vessel in the production stage during the previous cycle period, and operating the other adjacent vessel in the first equalization down stage when the vessel is operating in the first equalization up stage.

6. The method according to claim 1 further comprising operating each vessel in a third equalization down stage at the next cycle period following operating the vessel in the second equalization down stage and operating the vessel in a third equalization up stage during a cycle period just prior to operating the vessel in the second equalization up stage.

7. The method according to claim 6 further comprising operating each vessel in a fourth equalization down stage at the next cycle period following operating the vessel in the third equalization down stage and at a cycle period just prior to the blow-down stage, and operating the vessel in a fourth equalization up stage during a cycle period just prior to the third equalization up stage and just after the purge stage.

8. The method according to claim 1 wherein the plurality of vessels are coupled together through a plurality of open/shut valves.

9. The method according to claim 1 wherein the plurality of vessels are coupled together through a rotary feed valve and a rotary product valve.

10. The method according to claim 1 wherein the plurality of vessels are coupled together through a single rotary valve communicating with both the feed end and the product end of each vessel.

11. The method according to claim 1 wherein the PSA system purifies a reformate feed gas into a hydrogen product gas.

12. The method according to claim 11 wherein the hydrogen product gas is fed directly into a fuel cell.

13. The method according to claim 11 wherein the reformate feed gas contains less than 59% hydrogen.

14. The method according to claim 11 wherein the product gas recovers at least 70% of the hydrogen that is in the feed gas.

15. The method according to claim 11 wherein the product gas contains at least 95% hydrogen.

16. The method according to claim 11 wherein the product gas contains at least 99% hydrogen.

17. The method according to claim 11 wherein the product gas contains less than 1 ppm of carbon monoxide.

18. The method according to claim 11 wherein a first adsorbent in the vessels is selected from the group consisting of zeolite 5A, zeolite LiX and combinations thereof.

19. The method according to claim 18 wherein a second adsorbent in the vessels is selected from the group consisting of activated carbon, activated alumina, zeolite 13X, zeolite 4A and combinations thereof placed at the feed end of the vessel so that the feed gas first passes over the second adsorbent before contacting the first adsorbent.

20. The method according to claim 11 wherein the adsorbents in the vessels remove carbon monoxide, carbon dioxide, nitrogen and water.

21. The method according to claim 20 wherein the adsorbents in the vessels remove one or more of the impurities from the feed gas selected from the group consisting of methane, ethane, propane, butane, ethylene, propylene, hydrogen sulfide and NH₃.

22. The method according to claim 11 wherein the PSA system operates at a pressure below 7 atmospheres.

23. The method according to claim 22 wherein the PSA system operates at a pressure between 3 and 5 atmospheres.

24. The method according to claim 11 wherein the PSA system operates at a temperature between 20 and 100° C.

25. The method according to claim 24 wherein the PSA system operates at a temperature between 60 and 100° C.

26. The method according to claim 1 wherein providing a plurality of vessels includes providing at least five vessels.

27. The method according to claim 26 wherein providing a plurality of vessels includes providing nine vessels.

28. A method for cycling a pressure swing adsorption (PSA) system, said PSA system receiving a feed gas and emitting a purified product gas and an exhaust gas, said PSA system including a plurality of adsorbent vessels, each vessel including an adsorbent for adsorbing impurities in the feed gas, each vessel including a feed end responsive to the feed gas and emitting the exhaust gas, and a product end that emits the product gas, said method comprising:
operating each vessel of the plurality of vessels in a production stage for a plurality of cycle periods, wherein operating the vessel in the production stage includes delivering the feed gas to the feed end of the vessel and drawing the product gas from the product end of the vessel;
operating each vessel of the plurality of vessels in at least one equalization down stage following the production stage for at least one cycle period, wherein operating the vessel in the equalization down stage includes coupling the product end of the vessel to the product end of another vessel that is at a lower pressure to lower the pressure in the vessel;
operating each vessel of the plurality of vessels in a blow-down stage following the at least one equalization down stage for at least one cycle period, wherein operating the vessel in the blow-down stage further reduces the pressure in the vessel to an exhaust pressure;
operating each vessel of the plurality of vessels in a purge stage following the blow-down stage, wherein operating the vessel in the purge stage includes feeding reduced-pressure product gas into the product end of the vessel and emitting the exhaust gas through the feed end of the vessel;
operating each vessel of the plurality of vessels in at least one equalization up stage following the purge stage for at least one cycle period, wherein operating the vessel in the at least one equalization up stage includes increasing the pressure in the vessel;
operating each vessel of the plurality of vessels in a product pressurization stage following the at least one equalization up stage for at least one cycle period, wherein operating the vessel in the product pressurization stage includes pressurizing the vessel with the product gas to a product pressure; and
operating each vessel of the plurality of vessels in the production stage following the product pressurization stage.

29. The method according to claim 28 wherein operating the vessel in the at least one equalization up stage includes coupling the product end of the vessel to the product end of another vessel that is at a higher pressure.

30. The method according to claim 28 wherein operating the vessel in at least one equalization up stage includes coupling the feed end of the vessel to the feed end of another vessel that is at a higher pressure.

31. The method according to claim 28 wherein operating the vessel in at least one equalization up stage includes coupling the product end of the vessel to the product end of another vessel that is at a higher pressure and coupling the feed end of the vessel to the feed end of another vessel that is at a higher pressure.

32. The method according to claim 28 wherein operating the vessel in at least one equalization down stage includes operating the vessel in a plurality of consecutive equalization down stages to reduce the pressure of the vessel over more than one cycle period, and wherein operating the vessel in at least one equalization up stage includes operating the vessel in a plurality of consecutive equalization up stages to increase the pressure of the vessel over more than one cycle period.

33. The method according to claim 28 wherein the plurality of vessels are coupled together through a plurality of open/shut valves.

34. The method according to claim 28 wherein the plurality of vessels are coupled together through a rotary feed valve and a rotary product valve.

35. The method according to claim 28 wherein the plurality of vessels are coupled together through a single rotary valve communicating with both the fee end and the product end of each vessel.

36. The method according to claim 28 wherein the PSA system purifies a reformate gas into a hydrogen product gas.

37. The method according to claim 36 wherein the hydrogen product gas is fed directly into a fuel cell.

38. The method according to claim 36 wherein the reformate feed gas contains less than 59% hydrogen.

39. The method according to claim 36 wherein the product gas recovers at least 70% of the hydrogen that is in the feed gas.

40. The method according to claim 36 wherein the product gas contains at least 95% hydrogen.

41. The method according to claim 36 wherein the product gas contains at least 99% hydrogen.

42. The method according to claim 36 wherein the product gas contains less than 1 ppm of carbon monoxide.

43. The method according to claim 36 wherein a first adsorbent in the vessels is selected from the group consisting of zeolite 5A, zeolite LiX, and combinations thereof.

44. The method according to claim 43 wherein a second adsorbent in the vessels is selected from the group consisting of activated carbon, activated alumina, zeolite 13X, zeolite 4A and combinations thereof placed at the feed end of the adsorbent vessels so that the feed gas first passes over the second adsorbent before contacting the first adsorbent.

45. The method according to claim 36 wherein the adsorbents in the vessels remove carbon monoxide, carbon dioxide, nitrogen, and water.

46. The method according to claim 45 wherein the adsorbents in the vessels remove one or more of the impurities from the feed gas selected from the group consisting of methane, ethane, propane, butane, ethylene, propylene, hydrogen sulfide and NH₃.

47. The method according to claim 36 wherein the PSA system operates at a pressure below 7 atmospheres.

48. The method according to claim 47 wherein the PSA system operates at a pressure between 3 and 5 atmospheres.

49. The method according to claim 36 wherein the PSA system operates at a temperature between 20 and 100° C.

50. The method according to claim 49 wherein the PSA system operates at a temperature between 60 and 100° C.

51. The method according to claim 28 wherein providing a plurality of vessels includes providing at least five vessels.

52. A pressure swing adsorption (PSA) system for purifying a feed gas into a product gas, said system comprising:
a feed manifold responsive to the feed gas;
a product manifold outputting the product gas;
an exhaust manifold outputting an exhaust gas including impurities from the feed gas;
a plurality of vessels responsive to the feed gas from the feed manifold and outputting the product gas to the product manifold, said plurality of vessels including an adsorbent for adsorbing the impurities in the feed gas;
at least one feed valve coupled between the feed manifold and the plurality of vessels for controlling the feed gas applied to the vessels; and
at least one product valve coupled between the vessels and the product manifold for controlling the product gas drawn from the vessels to the product manifold, wherein the PSA system operates by a predetermined PSA cycle, said PSA cycle including operating each vessel of the plurality of vessels in a production stage for a plurality of cycle periods, wherein operating the vessel in the production stage includes delivering the feed gas to the feed end of the vessel and drawing the product gas from the product end of the vessel, operating each vessel of the plurality of vessels in a first equalization down stage following the production stage for at least one cycle period, wherein operating the vessel in the first equalization down stage includes coupling the product end of the vessel to the product end of an adjacent vessel that is at a lower pressure to lower the pressure in the vessel, operating each vessel of the plurality of vessels in a second equalization down stage following the first equalization down stage for at least one cycle period, wherein operating the vessel in the second equalization down stage includes coupling the product end of the vessel to the product end of another adjacent vessel that is at a purge pressure to further lower the pressure in the vessel, operating each vessel of the plurality of vessels in a blow-down stage following the second equalization down stage for at least one cycle period, wherein operating the vessel in the blow-down stage further reduces the pressure in the vessel to an exhaust pressure, operating each vessel of the plurality of vessels in a purge stage following the blow-down stage over a plurality of cycle periods, wherein operating the vessel in the purge stage includes feeding reduced-pressure product gas into the product end of the vessel and emitting the exhaust gas through the feed end of the vessel, operating each vessel of the plurality of vessels in a second equalization up stage following the purge stage for at least one cycle period, wherein operating the cycle in the second equalization up stage includes coupling the product end of the vessel to the product end of an adjacent vessel that is at a higher pressure to increase the pressure in the vessel, operating each vessel of the plurality of vessels in the first equalization up stage following a second equalization up stage for at least one cycle period, wherein operating the vessel in the first equalization up stage includes coupling the product end of the vessel to the product end of another adjacent vessel that is at a higher pressure to further increase the pressure in the vessel, and operating each vessel of the plurality of vessels in a product pressurization stage following the first equalization up stage for at least one cycle period, wherein operating the vessel in a product pressurization stage includes pressurizing the vessel with product gas from the product manifold to a product pressure for the production stage.

53. The system according to claim 52 wherein the at least one product valve is a plurality of product valves, a plurality of purge valves and a plurality of equalization valves.

54. The system according to claim 52 wherein the at least one feed valve is a plurality of feed valves and a plurality of exhaust valves.

55. The system according to claim 52 wherein the at least one feed valve is a single rotary feed valve, and the at least one product valve is a single rotary product valve.

56. The system according to claim 52 wherein the PSA system purifies a reformate feed gas into a hydrogen product gas.

57. The system according to claim 56 wherein the hydrogen product gas is fed directly into a fuel cell.

58. The system according to claim 56 wherein the reformate feed gas contains less than 59% hydrogen.

59. The system according to claim 56 wherein the product gas recovers at least 70% of the hydrogen that is in the feed gas.

60. The system according to claim 56 wherein the product gas contains at least 95% hydrogen.

61. The system according to claim 56 wherein the product gas contains at least 99% hydrogen.

62. The system according to claim 56 wherein the product gas contains less than 1 ppm of carbon monoxide.

63. The system according to claim 56 wherein a first adsorbent in the vessels is selected from the group consisting of zeolite 5A, zeolite LiX, and combinations thereof.

64. The system according to claim 63 wherein a second adsorbent in the vessels is selected from the group consisting of activated carbon, activated alumina, zeolite 13X, zeolite 4A and combinations thereof placed at the feed end of the adsorbent vessels so that the feed gas first passes over the second adsorbent before contacting the first adsorbent.

65. The system according to claim 56 wherein the adsorbents in the vessels remove carbon monoxide, carbon dioxide, nitrogen, and water.

66. The system according to claim 65 wherein the adsorbents in the vessels remove one or more of the impurities from the feed gas selected from the group consisting of methane, ethane, propane, butane, ethylene, propylene, hydrogen sulfide and NH₃.

67. The system according to claim 56 wherein the PSA system operates at a pressure below 7 atmospheres.

68. The system according to claim 67 wherein the PSA system operates at a pressure between 3 and 5 atmospheres.

69. The system according to claim 56 wherein the PSA system operates at a temperature between 20 and 100° C.

70. The system according to claim 69 wherein the PSA system operates at a temperature between 60 and 100° C.

71. The system according to claim 52 wherein the plurality of vessels is at least five vessels.
